(19) United States
(12) Patent Application Publication
(10) Pub. No.: US 2009/0125132 A1
(43) Pub. Date: May 14, 2009

(54) Sound Reproducer

(76) Inventor: Ichiro Kawashima, Osaka (JP)

Correspondence Address: MCDERMOTT WILL & EMERY LLP, 600 13TH STREET, NW, WASHINGTON, DC, 20005-3096, US

(21) Appl. No.: 11/794,574

(22) PCT Filed: Aug. 26, 2005
(86) PCT No.: PCT/JP2005/015568

§ 371 Date: Jul. 2, 2007

(30) Foreign Application Priority Data
Feb. 3, 2005 (JP) 2005-027330

(51) Int. Cl. G06F 17/00

(52) U.S. Cl. 700/94

(57) ABSTRACT

When an attenuation process is performed by a digital signal processor 302, information on the attenuation amount is notified to a control microcomputer 307 of an analog amplifier 304 and to an external amplifier, or the like, connected via a digital audio interface 306, whereby the amount of analog amplification can be adjusted at each section.

### TECHNICAL FIELD

The present invention relates to a sound reproducer for digitally processing audio data to create a sound field, and the like.

### BACKGROUND ART

With the recent spread of multi-channel environments and software such as DVDs, there is an increase in the variety of devices capable of reproducing digital audio data of two or more channels. The sound recorded on a DVD is typically 5.1-channel digital audio data (see Non-Patent Document 1), and normal reproduction thereof requires five speakers and one subwoofer for reproducing bass sound. Moreover, these five speakers are required to be capable of correctly reproducing bass components.

However, since it is unlikely that all households have such a speaker set, most DVD players are capable of lossless reproduction of all sound components even with a sub-5.1-channel speaker set. Specifically, a plurality of audio channels are mixed together so that the output sound components for the number of speakers are reproduced with a smaller number of speakers. With such a process, it is possible to realize lossless reproduction of recorded sound components even though the sound field is different from the intended sound field.

Where individual speakers are not capable of correctly reproducing bass components, e.g., small speakers, all the base components are together output from the subwoofer. This is to utilize the fact that the human's sense of hearing lacks localization for bass components.

The process of mixing together data of a plurality of channels is often used for other processes such as the process of artificially creating a sound field, for example, in addition to the process of reproducing all sound components with a small number of speakers.

Such a process is performed by a calculation, e.g., adding together data of the plurality of channels as shown in FIG. 1. However, since there is a limit on the range of values that can be represented by digital data, and the digitally-representable range may be exceeded upon addition 101 and 102 of data of the plurality of channels. Digital data exceeding the maximum value and having its sign reversed will be perceived as unpleasant noise. The noise is typically suppressed by a “clipping process” of replacing the overflowing value with the positive or negative maximum value. However, while the clipping process is capable of preventing harmful noise, it distorts the sound.

In order to avoid such a problem, it is necessary to uniformly attenuate all channels of digital data in advance by a normalization process 103 so that digital overflow does not occur upon the data addition 101 and 102. All channels are uniformly attenuated because if only some channels are attenuated, it will lose the volume balance between channels.

When digital data is attenuated, the final output volume will be small. Therefore, it is necessary to compensate for the level by an analog circuit. That is, after digital data is converted to analog data by a DA converter, the volume needs to be increased by an analog amplifier.

FIG. 2 is a block diagram showing a configuration of a conventional sound reproducer. As shown in FIG. 2, information read out from a recording medium, or the like, is converted by a front end processor 201 to digital data 211 and is input to a digital signal processor 202.

The digital signal processor 202 performs various audio processes on the received digital data 211. For example, the digital signal processor 202 decodes the digital data 211, or performs a sound field process thereon based on a control signal 216 from a control microcomputer 207. Since the normalization process is performed as necessary, an attenuated digital audio signal 212 is produced. The digital audio signal 212 is converted by a DA converter 203 to an analog audio signal 213.

The analog audio signal 213 is amplified by an analog amplifier 204. The amount of amplification by which the analog audio signal 213 is amplified by the analog amplifier 204 is defined by an amplification level control signal 217 output from the control microcomputer 207. The analog audio signal 213 is amplified based on the amount of amplification.

The amplification level control signal 217 is calculated in the control microcomputer 207 based on the digital data 211 input to the digital signal processor 202 and based on the control signal 216 for controlling the operation of the digital signal processor 202.

An analog audio signal 214 amplified by the analog amplifier 204 is reproduced by a speaker 205. The digital interface audio signal 215 is output from a digital audio interface 206 while being attenuated.

Non-Patent Document 1: Dolby Licensee Information Manual: Dolby Digital Consumer Decoder Issue 5

### DISCLOSURE OF THE INVENTION

### Problems to be Solved by the Invention

However, depending on the audio process and the input digital data, the channel mixing process at the digital signal processor 202 varies, and the normalization level required varies. Thus, each time the system operation status changes, it is necessary to recalculate the normalization level at the digital signal processor 202 so as to adjust the amount of amplification at the analog amplifier 204. This process has three problems as follows.

Firstly, since the process at the digital signal processor 202 varies from one product to another, it is not easy to calculate the amount of amplification to be set in the analog amplifier 204. It complicates the control system, and also makes it necessary to redesign the entire system each time the digital signal processor 202 is replaced by another, thus leading to an increase in the cost for circuit design and control system development.

Secondly, there is a time delay between when the digital signal processor 202 performs the normalization process and when the analog audio signal 213 is input to the analog amplifier 204, whereby it is difficult to control the timing at which to change the analog amplification level.

Thirdly, where a plurality of sound field adjustment functions are used at the digital signal processor 202, the internal parameters change in a complicated manner depending on input conditions. Therefore, conditions by which the digital signal processor 202 changes the normalization process are very complicated, and it is very difficult to calculate the analog amplification level for compensating for the normalization process.

In order to solve these problems, there is a method in which the output level at the digital signal processor 202 is always attenuated so as to be standardized at a low level, while the analog amplification level is always kept at a constant high level. With this method, it is possible to prevent the digital data overflow or the degradation of the sound quality due to the clipping process. Moreover, it is not necessary to frequently adjust the level of the analog amplifier 204.

However, the sound quality is degraded with this method because the digital output is always suppressed to a low level and because inexpensive DA converters generally have poor analog output characteristics for digital inputs of lower levels. In order to improve the sound quality, the DA converter 203, the analog circuit for transferring the analog audio signal 213 and the analog amplifier 204 each need to be a high-quality component.

With a method in which all the channels are uniformly attenuated, a fundamental problem is that channels that do not need to be attenuated are also attenuated, thus degrading the sound quality for those channels.

Moreover, where a digital audio signal is attenuated by a digital audio reproducing device such as a DVD decoder and the attenuated digital audio signal is input to a different device such as an AV amplifier, the above-described method in which the digital output level is suppressed to a low level and the analog amplification level is set to be high cannot be employed in an audio system including a plurality of devices because the information about the attenuation of the input digital audio signal is not transmitted to the AV amplifier, or the like.

The present invention has been made in view of these problems, and has an object to minimize the deterioration of the sound quality, which occurs when performing a sound field process on a digital audio signal.

### Means for Solving the Problems

In order to achieve the object set forth above, in the present invention, when an attenuation process is performed by a digital signal processor, information indicative of the attenuation amount is notified to a controller of an analog amplifier and to an external amplifier, whereby the analog amplification amount can be adjusted at each section.

Specifically, the present invention provides a sound reproducer for digitally processing and reproducing digital audio data having a plurality of channels, including:

a digital signal processor for digitally processing the digital audio data so that all channels of the digital audio data are uniformly attenuated and for outputting information indicative of an amount of the attenuation;

a DA converter for converting the digital audio signal, which has been digitally processed by the digital signal processor, to an analog audio signal;

a controller device for calculating a level by which the analog audio signal should be compensated for based on the attenuation amount information to thereby output an amplification level control signal; and

an analog amplifier for setting an amount of amplification for the analog audio signal based on the amplification level control signal output from the controller device and for amplifying the analog audio signal by the amount of amplification.

Thus, according to the present invention, when the digital attenuation amount varies, the final output level can be kept constantly simply by setting the analog amplification amount by referring only to the attenuation amount information output from the digital signal processor. Then, the attenuation of the digital level is minimized, whereby it is possible to minimize the deterioration of the sound quality.

The present invention also provides a sound reproducer for digitally processing and reproducing digital audio data having a plurality of channels, including:

a digital signal processor for digitally processing the digital audio data so that channels of the digital audio data are selectively attenuated and for outputting information indicative of an amount of the attenuation;

a DA converter for converting the digital audio signal, which has been digitally processed by the digital signal processor, to an analog audio signal;

a controller device for calculating a level by which the analog audio signal should be compensated for based on the attenuation amount information to thereby output an amplification level control signal; and

an analog amplifier for setting an amount of amplification for the analog audio signal based on the amplification level control signal output from the controller device and for amplifying the analog audio signal by the amount of amplification.

Thus, according to the present invention, by making a system in which it is possible to individually adjust the amount of amplification at the analog amplifier for each channel, it is possible to minimize the normalization process and to maintain a sound quality even higher than that obtained where all the channels are uniformly attenuated.

In one embodiment of the present invention, the digital signal processor produces and outputs a test audio signal to the analog amplifier and calculates, as a delay time, an amount of time required from the production of the test audio signal to the reception of the test audio signal at the analog amplifier.

Thus, according to the present invention, the digital signal processor can correctly obtain the timing at which the amount of amplification at the analog amplifier should be changed, which is advantageous for preventing a problem that the amount of amplification at the analog amplifier is changed at a wrong timing.

In one embodiment of the present invention, the sound reproducer further includes an interface for outputting the digital audio data in a general-purpose PCM audio communications format, wherein the interface outputs, to an external amplifier device, the attenuation amount for all the channels or the attenuation amount for each channel, being added to the PCM audio communications format.

Thus, according to the present invention, there is provided an interface for outputting the digital audio data in a general-purpose PCM audio communications format such as IEC60958 or ADAT. Therefore, the present invention is not limited to the process of adjusting the digital attenuation amount and the analog amplification amount within a single sound reproducer. Even if a device performing the digital audio process and a device for performing the analog amplification process are separate devices, e.g., a combination of a DVD player and an AV amplifier, it is possible to adjust the digital attenuation amount and the analog amplification amount.

### EFFECTS OF THE INVENTION

According to the present invention, no matter what kind of an audio process is performed, it is possible to make an adjustment such that the level of the final output sound will not be varied. Moreover, even with a system where the performance of the DA converter is not high, it is possible to theoretically minimize the degradation of the sound quality.

### BRIEF DESCRIPTION OF THE DRAWINGS

FIG. 1 is a diagram showing a conventional normalization process.

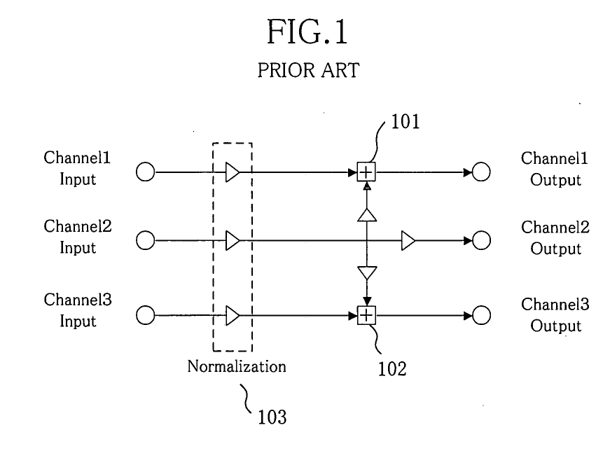

FIG. 2 is a block diagram showing a conventional sound reproducer.

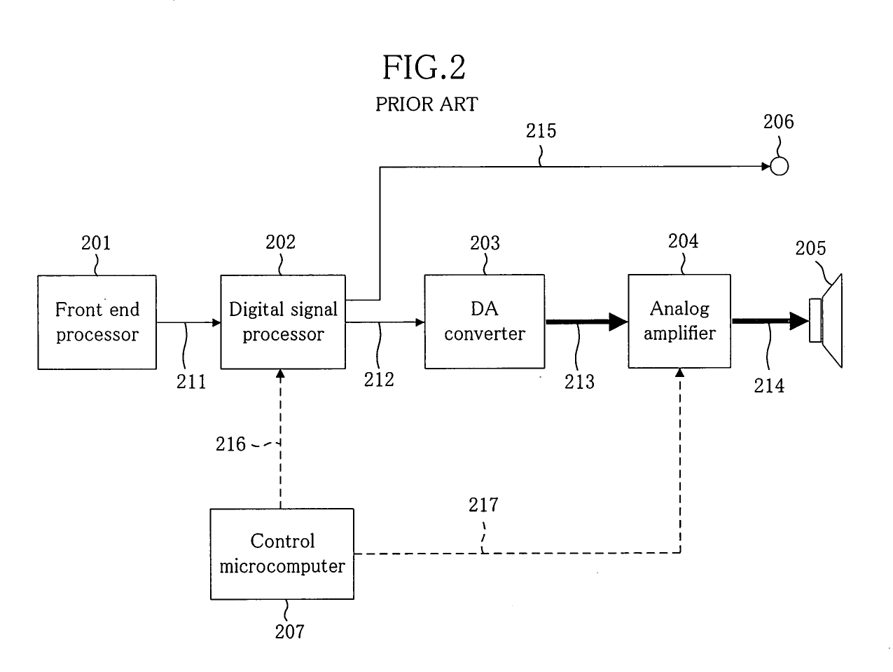

FIG. 3 is a block diagram showing a sound reproducer according to an embodiment of the present invention.

FIG. 4 is a diagram showing a normalization process according to an embodiment of the present invention.

### DESCRIPTION OF REFERENCE NUMERALS

301 Front end
302 Digital signal processor
303 DA converter
304 Analog amplifier
305 Speaker
306 Digital audio interface
307 Control microcomputer

### BEST MODE FOR CARRYING OUT THE INVENTION

A preferred embodiment of the present invention will now be described with reference to the drawings. The following description of a preferred embodiment is merely illustrative of the present invention, and is not intended to limit the present invention itself or the application thereof.

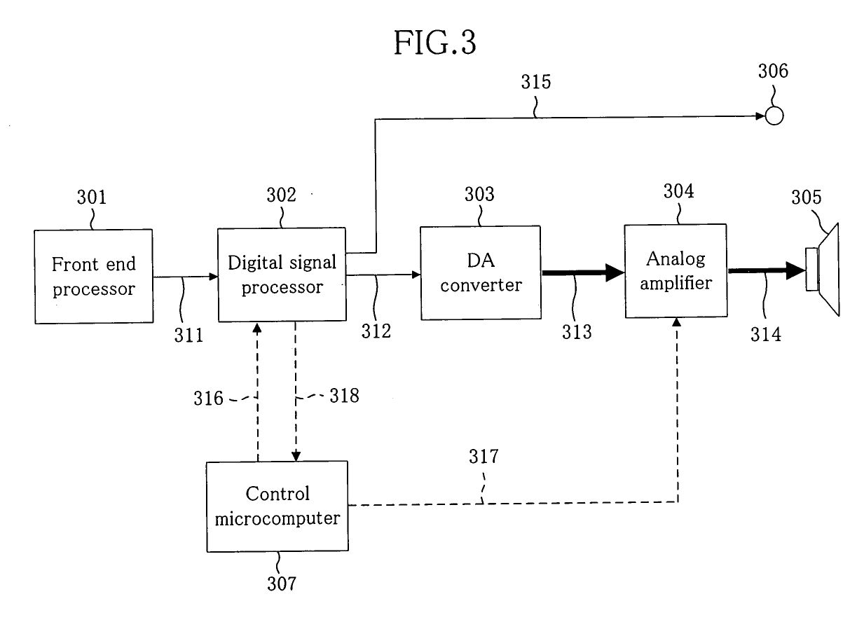

FIG. 3 is a block diagram showing a configuration of a sound reproducer according to an embodiment of the present invention. As shown in FIG. 3, information read out from a recording medium, or the like, is converted by a front end processor 301 to digital data 311 and is input to a digital signal processor 302.

The digital signal processor 302 performs various audio processes on the received digital data 311. For example, the digital signal processor 302 decodes the digital data 311, or performs a sound field process thereon based on a control signal 316 from a control microcomputer 307. The normalization process is performed as necessary. Whether or not the normalization process is necessary is determined separately for each channel, and only the digital data 311 for the channel for which the normalization process is determined to be necessary is attenuated.

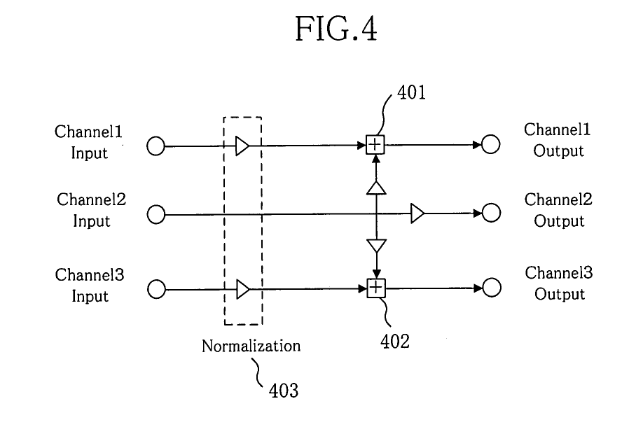

As shown in FIG. 4, the normalization process is not performed for the channel for which the normalization process is determined to be not necessary (Channel 2 in FIG. 4). The information on the normalization process is input as attenuation amount information 318 to the control microcomputer 307. Moreover, normalization level information is recorded in the stream information recording field of the digital interface audio signal 315. Then, the digital audio signal 312 is converted by a DA converter 303 to an analog audio signal 313.

The analog audio signal 313 is amplified by an analog amplifier 304. The amount of amplification by which the analog audio signal 313 is amplified by the analog amplifier 304 is defined by an amplification level control signal 317 output from the control microcomputer 307. The analog audio signal 313 is amplified based on the amount of amplification.

The amplification level control signal 317 is produced by the control microcomputer 307 calculating the compensation level based on the attenuation amount information 318 for each channel.

A test audio signal is output from the digital signal processor 302, and the test audio signal is input to the analog amplifier 304. Then, the digital signal processor 302 calculates the amount of time required from the production of the test audio signal to the reception of the test audio signal at the analog amplifier 304, and the calculated amount of time is stored as a delay time.

By calculating the delay time as described above, it is possible to adjust the output timing at which to output the amplification level control signal 317 from the control microcomputer 307 to the analog amplifier 304. Thus, the digital signal processor 302 can correctly obtain the timing at which the amount of amplification at the analog amplifier 304 should be changed, which is advantageous for preventing a problem that the amount of amplification at the analog amplifier 304 is changed at a wrong timing.

Then, an analog audio signal 314, which has been amplified, is reproduced by a speaker 305. The digital interface audio signal 315 is output from a digital audio interface 306.

The digital interface audio signal 315 is output in a general-purpose PCM audio communications format, such as IEC60958 or ADAT, and includes attenuated digital audio information as described above and the attenuation amount information 318 for each channel. Thus, a device connected to the digital audio interface 306 can adjust the analog amplification level by using the attenuation amount information 318 as does the control microcomputer 307.

With such a configuration, even if a device performing the digital audio process and a device for performing the analog amplification process are separate devices, e.g., a combination of a DVD player and an AV amplifier, it is possible to adjust the digital attenuation amount and the analog amplification amount between these devices.

### INDUSTRIAL APPLICABILITY

With the sound reproducer of the present invention, it is possible to suppress the fluctuation in the final output sound and to minimize the deterioration of the sound quality no matter what kind of an audio process is performed by a digital signal processor. Moreover, it also provides a highly practical advantage in that it is possible to significantly reduce the number of steps required in designing the system after the digital signal processor is replaced by another. Thus, the present invention is very useful and has a high level of industrial applicability.

1. A sound reproducer for digitally processing and reproducing digital audio data having a plurality of channels, comprising:
a digital signal processor for digitally processing the digital audio data so that all channels of the digital audio data are uniformly attenuated and for outputting information indicative of an amount of the attenuation;
a DA converter for converting the digital audio signal, which has been digitally processed by the digital signal processor, to an analog audio signal;
a controller device for calculating a level by which the analog audio signal should be compensated for based on the attenuation amount information to thereby output an amplification level control signal; and
an analog amplifier for setting an amount of amplification for the analog audio signal based on the amplification level control signal output from the controller device and for amplifying the analog audio signal by the amount of amplification,
wherein the attenuation process at the digital signal processor and the compensation level calculation process at the controller device are preformed in parallel to each other.

2. A sound reproducer for digitally processing and reproducing digital audio data having a plurality of channels, comprising:
a digital signal processor for digitally processing the digital audio data so that channels of the digital audio data are selectively attenuated and for outputting information indicative of an amount of the attenuation:
a DA converter for converting the digital audio signal, which has been digitally processed by the digital signal processor, to an analog audio signal;
a controller device for calculating a level by which the analog audio signal should be compensated for based on the attenuation amount information to thereby output an amplification level control signal; and
an analog amplifier for setting an amount of amplification for the analog audio signal based on the amplification level control signal output from the controller device and for amplifying the analog audio signal by the amount of amplification,
wherein the attenuation process at the digital signal processor and the compensation level calculation process at the controller device are performed in parallel to each other.

3. The sound reproducer of claim 1, wherein the digital signal processor produces and outputs a test audio signal to the analog amplifier and calculates, as a delay time, an amount of time required from the production of the test audio signal to the reception of the test audio signal at the analog amplifier.

4. The sound reproducer of claim 1, further comprising an interface for outputting the digital audio data in a general-purpose PCM audio communications format, wherein the interface outputs, to an external amplifier device, the attenuation amount for all the channels or the attenuation amount for each channel, being added to the PCM audio communications format.
